(19) United States
(12) Patent Application Publication
(10) Pub. No.: US 2025/0099984 A1
(43) Pub. Date: Mar. 27, 2025

(54) DEVICE FOR DISPENSING A FLUID PRODUCT

(71) Applicant: APTAR FRANCE SAS, LE NEUBOURG (FR)

(72) Inventors: Teo BENARD, Rouen (FR); Sébastien MICHAUX, Le Petit Quevilly (FR); Ludovic PETIT, Vitot (FR)

(73) Assignee: APTAR FRANCE SAS, LE NEUBOURG (FR)

(21) Appl. No.: 18/836,589

(22) PCT Filed: Feb. 8, 2023
(86) PCT No.: PCT/FR2023/050167

§ 371 Date: Aug. 22, 2024

(30) Foreign Application Priority Data
Feb. 8, 2022 (FR) FR2201105

(51) Int. Cl. B05B 1/26; B05B 1/06; B05B 1/30

(52) U.S. Cl. CPC B05B 1/265; B05B 1/06; B05B 1/3073

(57) ABSTRACT

Device for dispensing a fluid product having a reservoir suitable for containing a dose of fluid product and a dispensing head. The dispensing head having a cannula with a dispensing opening and defining an expulsion channel. The dispensing opening having a spray tip that is partially inserted into the expulsion channel. The spray tip having a head part arranged outside of the cannula and a rod part inserted into the expulsion channel. The head part extending the rod part and having a diameter which is greater than the diameter of the rod part to define an impact surface downstream of the dispensing opening, such that during actuation, the fluid product flowing under pressure in the expulsion channel strikes the impact surface in order to generate a spray.

The present invention relates to a device for dispensing a fluid product, in particular intended for the administration of a pharmaceutical product on small animals, such as, for example, mice.

Prior-art devices used to administer doses of drugs to small animals, such as rodents, in particular mice, are generally single-dose, single-use devices, in which the entire dose of product is dispensed in one single actuation. Yet, drug tests on animals, in particular rodents such as mice, are generally carried out on fifteen rodents, which therefore requires fifteen devices. In addition, the doses are generally not adjustable, such that a different device is required for each different dosage.

Moreover, these devices generally use a small-diameter cannula to dispense the fluid product. Yet, this carries out a dispensing of a dose in the form of a rectilinear jet, while it is preferable to be able to carry out this dispensing in the form of a spray. In particular, in the scope of preclinical tests on small animals, a spray with a Dv50 of between 15 and 40 μm is desirable.

The present invention aims to provide a device for dispensing a fluid product which does not reproduce the above-mentioned disadvantages.

The present invention in particular aims to provide a device for dispensing a fluid product which makes it possible to dispense several doses in several successive uses.

The present invention also aims to provide a device for dispensing a fluid product which makes it possible to modify the dosage on each use.

The present invention also aims to provide a device for dispensing a fluid product which makes it possible to dispense the fluid product at the outlet of a small-diameter cannula in the form of a spray.

The present invention also aims to provide a device for dispensing a fluid product which is simple and reliable to use.

Another object of the present invention is to provide a device for dispensing a fluid product that is simple and inexpensive to manufacture and to assemble.

The present invention therefore aims for a device for dispensing a fluid product comprising a reservoir suitable for containing at least one dose of fluid product and a dispensing head attached to said reservoir, said dispensing head comprising a cannula provided with a dispensing opening and defining an expulsion channel, said dispensing opening comprising a spray tip partially inserted into said expulsion channel, said spray tip comprising a head part arranged outside said cannula and a rod part inserted into said expulsion channel, said head part being an extension of the rod part and comprising a diameter that is greater than the diameter of said rod part in order to define an impact surface downstream of said dispensing opening, such that during actuation, said fluid product flowing under pressure in said expulsion channel strikes said impact surface in order to generate a spray, wherein the diameter of said rod part is less than the diameter of said expulsion channel, said rod part being centred in said expulsion channel, said rod part being attached in said expulsion channel, in particular by clamping at one or more deformation points made on said cannula.

Advantageously, the maximum external diameter of said head part is similar, in particular identical, to the external diameter of said cannula.

According to a first advantageous embodiment, said head part is spherical, such that said impact surface is curved.

According to a second advantageous embodiment, said head part is conical at its junction with said rod part, such that said impact surface is flat and forms a cone flaring outwards.

Advantageously, said dispensing head is removably connected to said reservoir.

Advantageously, said dispensing head comprises an attachment member suitable for being removably attached to said reservoir, in particular via a Luer-type attachment, said cannula being attached, in particular welded, to said attachment member.

Advantageously, the diameter of said expulsion channel is less than 1 mm, advantageously less than 0.8 mm, preferably around 0.7 mm.

Advantageously, said cannula is curved or bent.

Advantageously, said reservoir is a syringe comprising a body and a piston sliding into said body during actuation.

Advantageously, the spray generated has a Dv50 of less than 40 μm, in particular around 30 μm.

These characteristics and advantages and others of the present invention appear more clearly from the following detailed description, given by way of non-limiting example, and with reference to the accompanying drawings, and in which:

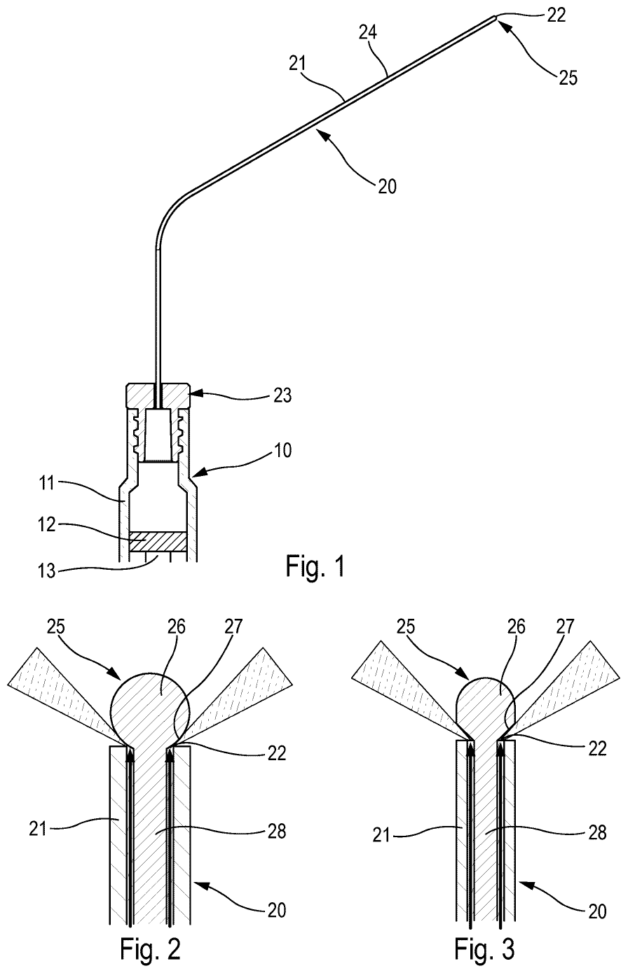

FIG. 1 is a diagrammatic cross-sectional view of a fluid product dispensing device according to one advantageous embodiment,

FIG. 2 is a detailed view of a spray tip according to a first advantageous embodiment,

FIG. 3 is a view similar to that of FIG. 2, showing a spray tip according to a second advantageous embodiment,

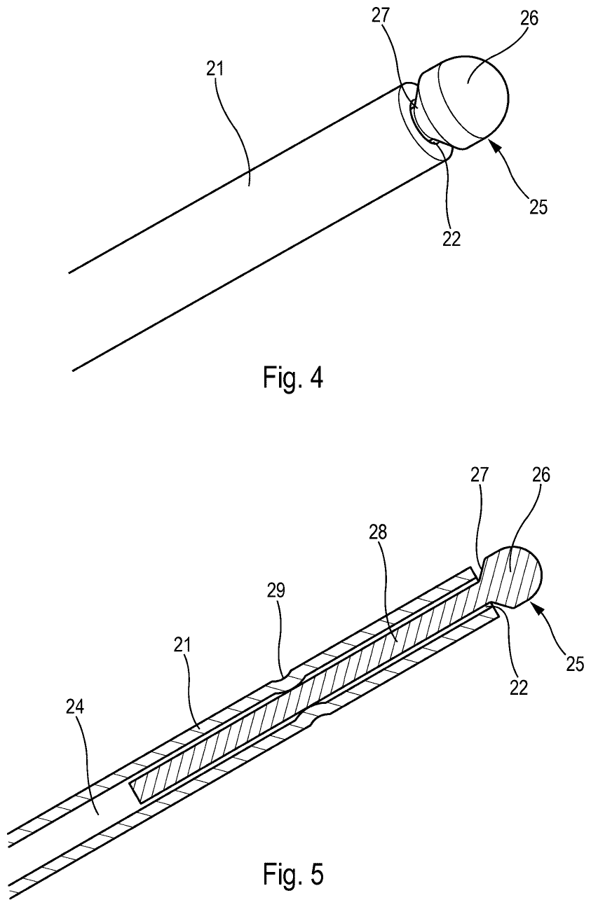

FIG. 4 is a perspective, partial, schematic view of the spray tip of FIG. 3, and.

FIG. 5 is a cutout, perspective, partial, schematic view of the spray tip of FIGS. 3 and 4.

The device for dispensing a fluid product represented in FIG. 1 comprises a reservoir 10 containing one or more doses of fluid product and a dispensing head 20 comprising a cannula 21 having a dispensing opening 22 provided with a spray tip 25, said cannula 21 being attached in an attachment member 23 which is suitable for being removably attached to the reservoir 10.

The cannula 21 forms a hollow tube defining a small-diameter expulsion channel 24, typically less than 1 mm, advantageously less than 0.8 mm, preferably around 0.7 mm. In the example represented, the cannula 21 is bent, but it could be straight or curved, or of any suitable shape. It can be rigid, or, in a variant, partially or totally flexible. Advantageously, the rear part of the cannula 21 is welded to the attachment member 23, but other attachment means can be considered, for example, a force-fitting or a gluing.

The reservoir 10 is advantageously a syringe comprising a body 11 and a piston 12 sliding into said body 11 during actuation. A piston rod 13 can be attached to the piston 12 to enable the user to actuate the device. The body 11 comprises an open front end which is suitable for removably receiving said attachment member 23. This attachment member 23 can be attached to the reservoir 10, for example, via a conventional Luer Lock-type attachment. Other attachment means can be considered, for example, a screwing or a snap-fitting.

The spray tip 25 provided at the dispensing opening 22 of the cannula 21 makes it possible to carry out the dispensing of the fluid product in the form of a spray.

This spray tip 25 forms an insert which is partially inserted into the expulsion channel 24 of the cannula, and which comprises a head part 26 and a rod part 28.

The rod part 28 penetrates into the expulsion channel 24, and therefore comprises a diameter which is less than the diameter of said expulsion channel 24. Advantageously, the rod part 28 is centred in the expulsion channel 24, which therefore extends all around said rod part 28. Advantageously, the rod part 28 is attached in the expulsion channel 24 by clamping at one or more deformation points 29 made on the cannula 21, as can be seen in FIG. 5.

The head part 26 is arranged outside the cannula 21 and extends the rod part 28. It comprises a diameter which is greater than the diameter of the rod part 28 and defines an inclined impact surface 27 after the outlet 22 of the cannula 21 for the fluid product flowing in the expulsion channel 24.

Thus, during actuation, the fluid product flows under pressure in the expulsion channel 24, around the rod part 28, and impacts the impact surface 27, which splits the particles of the fluid product and generates a spray. According to the shape of this impact surface 27, the properties of the spray generated can be modified.

Advantageously, the maximum external diameter of the head part 26 is similar to the external diameter of the cannula 21, preferably almost identical. Thus, the presence of the spray tip 25 does not increase the external diameter of the cannula, and does not modify its use.

A first embodiment is represented in FIG. 2, in which the head part 26 is spherical, such that the impact surface 27 is curved.

A second embodiment is represented in FIG. 3, in which the head part 26 is conical at its junction with the rod part 28, such that the impact surface 27 is flat and forms a cone flaring outwards.

Tests of these two embodiments have made it possible to establish that:
the invention makes it possible to generate a correct spray, by being based, on the one hand, on the geometry and the velocity of the spray, and, on the other hand, on the particle size of the spray drops (DSD: “Drop Size Distribution”); thus, the two embodiments described above make it possible to obtain a Dv50 of less than 50 μm;
the second embodiment has improved spray properties, with an average Dv50 at 30 μm, while the first embodiment gives an average Dv50 at 40 μm.

A preferred operation of the device represented in FIG. 1 will now be described.

Before the first use, the reservoir 10 can be empty and separated from the dispensing head 20. It is thus preferably closed by a stopper (not represented), in a known manner.

The user who wishes to use the device removes the stopper from the reservoir 10 and fills it with fluid product. For example, in the case of a syringe, it suctions fluid product from a fluid product reserve, by pulling the piston 12 away from the front end of the body 11. The reservoir 10 can be filled with a chosen dose of volume, or in a variant, with two or more doses.

The device is thus ready for its first active use, to dispense a dose of fluid product.

When the user presses on the piston rod 13, they move the piston 12 with respect to the body 11. Fluid product contained in the reservoir 10 is thus expelled into the cannula a 21, then sprayed through the spray tip 25. Advantageously, all of the fluid product contained in the reservoir 10 is dispensed in one single actuation. In a variant, the contents of the reservoir can be dispensed in two or more successive actuations.

When the reservoir 10 is empty, the user can remove the dispensing head 20, and refill the reservoir 10 in a known manner for a future use of the device.

It must be noted that the spray tip described above could also be used with a pre-filled reservoir and/or a single-use device, which is disposable after use.

Although the present invention has been described with reference to an advantageous embodiment, it is understood that a person skilled in the art can provide various modifications to it, without going beyond the scope of the present invention, such as defined by the accompanying claims.

1-10. (canceled)

11. Device for dispensing a fluid product comprising a reservoir (10) which is suitable for containing at least one dose of fluid product and one dispensing head (20) attached to said reservoir (10), said dispensing head (20) comprising a cannula (21) provided with a dispensing opening (22) and defining an expulsion channel (24), wherein said dispensing opening (22) comprises a spray tip (25) which is partially inserted into said expulsion channel (24), said spray tip (25) comprising a head part (26) arranged outside of said cannula (21) and a rod part (28) inserted into said expulsion channel (24), said head part (26) extending the rod part (28) and comprising a diameter which is greater than the diameter of said rod part (28) to define an impact surface (27) downstream of said dispensing opening (22), such that during actuation, said fluid product flowing under pressure in said expulsion channel (24) strikes said impact surface (27) in order to generate a spray, wherein the diameter of said rod part (28) is less than the diameter of said expulsion channel (24), said rod part (28) being centred in said expulsion channel (24), said rod part (28) being attached in said expulsion channel (24) by clamping at one or more deformation points (29) made on said cannula (21), the maximum external diameter of said head part (26) being similar, in particular identical, to the external diameter of said cannula (21), so that the spray tip (25) does not increase the external diameter of the cannula (21).

12. Device according to claim 11, wherein said head part (26) is spherical, such that said impact surface (27) is curved.

13. Device according to claim 11, wherein said head part (26) is conical at its junction with said rod part (28), such that said impact surface (27) is flat and forms a cone flaring outwards.

14. Device according to claim 11, wherein said dispensing head (20) is removably connected to said reservoir (10).

15. Device according to claim 11, wherein said dispensing head (20) comprises an attachment member (23) which is suitable for being removably attached to said reservoir (10), in particular via a Luer-type attachment, said cannula (21) being attached, in particular welded, to said attachment member (23).

16. Device according to claim 11, wherein the diameter of said expulsion channel (24) is less than 1 mm, advantageously less than 0.8 mm, preferably around 0.7 mm.

17. Device according to claim 11, wherein said cannula (21) is curved or bent.

18. Device according to claim 11, wherein said reservoir (10) is a syringe comprising a body (11) and a piston (12) sliding into said body (11) during actuation.

19. Device according to claim 11, wherein said device is adapted to generate a spray having a Dv50 of less than 40 μm, in particular around 30 μm.
